(19) United States
(12) Patent Application Publication
(10) Pub. No.: US 2014/0193625 A1
(43) Pub. Date: Jul. 10, 2014

(54) METHOD FOR PRODUCING A COMPONENT FROM A COMPOSITE FIBER MATERIAL AND COMPOSITE FIBER MATERIAL COMPONENT

(71) Applicants: Daniel Häffelin, Munich (DE); Swen Zaremba, Munich (DE); Bernd Zacherle, Regglisweiler (DE)

(72) Inventors: Daniel Häffelin, Munich (DE); Swen Zaremba, Munich (DE); Bernd Zacherle, Regglisweiler (DE)

(73) Assignee: TECHNISCHE UNIVERSITÄT MÜNCHEN, Munich (DE)

(21) Appl. No.: 14/127,539

(22) PCT Filed: Jul. 12, 2012
(86) PCT No.: PCT/EP2012/002932

§ 371 Date: Mar. 14, 2014

(30) Foreign Application Priority Data
Jul. 13, 2011 (DE) 10 2011 107 683.6
Jul. 13, 2011 (EP) PCT/EP2011/003497
Dec. 23, 2011 (DE) 10 2011 122 233.6

(51) Int. Cl. B32B 7/02; B32B 37/04

(52) U.S. Cl. CPC B32B 7/02; B32B 37/04
USPC 428/217; 264/257

(57) ABSTRACT

A process for the production of a component (1) made of a fiber composite material, and also a component (1) produced in this way, are stated, where a foil composite (7) with a thermoplastic outer foil (6) and with a thermoplastic inner foil (5) is produced, where the modulus of elasticity (E) of the inner foil (5) within a temperature range is smaller than the modulus of elasticity (E) of the outer foil (6), the inner foil (5) of the foil composite (7) is bonded to a molding (4) comprising a fiber material (2) and comprising a thermoset (3), the molding (4) is hardened, and the foil composite (7) is subjected to a heat treatment in the temperature range within which the modulus of elasticity (E) of the inner foil (5) is smaller than the modulus of elasticity (E) of the outer foil (6), where the outer foil (6) undergoes stress relaxation.

The invention relates to a process for the production of a component made of a fiber composite material, where a molding comprising a fiber material and comprising a thermoset is hardened. The invention further relates to a correspondingly produced component made of a fiber composite material. The invention is concerned here in particular with the surface finishing of a component of this type.

Fiber composite materials are produced by a time-consuming and expensive process. The fiber composite material is composed of a proportion of fibers and of a proportion of matrix, and the material here is a result of processing. By way of example, before matrix and fibers are combined, for example by infusion or injection, it is conventional to produce a dry preform made of fibers and approximating the final shape of the component. The production of a preform proceeds inter alia via the mutual superposition of fiber sheets which, with application of pressure and heat, can be pressed into a form that approximates the final shape. The matrix, and with this the prefabricated component, is then hardened.

Matrix material used can comprise thermosets, which can be composed of a plurality of components. Typical representative materials are epoxy-based, vinyl-based, polyester-based, and phenol-based resin systems. These exhibit a curing reaction which takes place at room temperature or at higher temperatures.

When the present document mentions the term molding, which comprises the fiber material and a thermoset, the meaning of this term is intended to comprise the states in which a semi-finished fiber product occurs during mechanical operations or during processing, from combination with the thermoset until hardening. The term molding therefore in particular comprises the states in which a preform occurs during mechanical operations or during processing, from the introduction of the thermoset until final shaping and hardening.

By virtue of the production process for fiber composite components, they exhibit a characteristic surface structure which has hitherto restricted their range of possible uses. Because of anisotropy present in the thickness direction, the fiber structure is perceptible under the surface of these materials. Production of a smooth surface that is demanded by way of example in the vehicle industry or aircraft industry, and in products in everyday use, etc. requires complicated and expensive downstream mechanical operations on fiber composite components. An example here is a requirement for repeated coating of the surface of a fiber composite component, with intermediate curing and sanding. An alternative possibility is subsequent application of foil to a fiber composite component, which by way of example can be achieved by using a spray process to apply various layers which react chemically to form a foil. Another possibility is a thermal or mechanical deep-drawing process for the application of foils, where two-dimensional foils are heated and/or stretched with reduction of wall thickness to give the intended shape.

Because of the enormous weight reduction that can be achieved with fiber composite materials, particularly in the automobile industry, expensive measures for the finishing of the surface are also accepted, an example being the integration of intermediate layers, the use of comparatively expensive resins with low shrinkage, or the use of semi-finished fiber products of high quality.

The cost for the surface finishing of fiber composite parts here can make up more than 50% of the total cost of the component.

EP 1 724 098 A1 discloses that, in order to improve the production process and for the surface finishing of a fiber composite component, a separate layer of material is first preformed, corresponding to the desired final shape, fiber material is applied to said preformed layer of material, the fiber material is cured by means of a resin to give the final product. The additional layer of material here becomes bonded to the fiber material and in particular gives a desired surface on one side.

The preformed additional layer of material can also be transported in the form of preform with the applied fiber material to the final process. The preformed layer of material here serves to some extent as a mold. For the additional layer of material preference is given to the use of plastics foils made of PET (polyethylene terephthalate), PC (polycarbonate), PA (polyamide), PMMA (polymethyl methacrylate), PBT (polybutylene terephthalate), PUR (polyurethane), and also to acrylic films, and mixtures of the abovementioned materials.

DE 10 309 811 A1 discloses a similar process, where a plastics foil molded to give the final shape of the desired component is produced by means of a mold which has the topography of the surface of the finished component. A fiber-reinforced plastic is applied to that side of the preformed foil that is not the surface of the finished component. After hardening of the reinforced plastic, the finished component is removed.

The same process for the production of a surface-finished fiber composite material can also be found in DE 10 2008 009 438 A1. Here, a cut-to-size surface foil is heated up to the softening point and is molded in a mold in accordance with the topography of the molding that is to be produced. A woven fiber fabric and a polymer resin are applied to the inner side of the preformed surface foil, molded in accordance with the topography of the molding, and hardened. After hardening, the finished component is removed from the mold.

A disadvantage in this process is that separate performing of the subsequent surface is necessary as an additional operation. Furthermore, the stated process can provide only single-side surface finishing.

In relation to an alternate production process for a fiber composite material, DE 20 2005 005 475 U1 discloses that a profiled preform with a sandwich structure can be utilized. The preform here comprises a stack made of core layers and of foil layers. In the interior there is an unreacted fiber material-resin layer optionally on a stiffening core. The arrangement also has an outer foil layer, a nonwoven layer and, for sealing with respect to the environment, a foil layer having durable resilience. The preform is intended to behave like a foil, so that it can be shaped by means of a foil-thermoforming system, and hardened.

It is disadvantageous that, because of lack of mechanical stability, the preform with a sandwich structure is difficult to transport. The resin introduced can moreover harden undesirably during transport.

DE 100 27 129 C1 also discloses a preform for the production of a component made of a fiber composite material. The preform here is composed of fiber material which can also take the form of layers and which can already have a three-dimensional shape. A sheathing means encloses the fiber material and is composed of an intermediate resilient plastics material. The sheathing means has by way of example been provided in the form of a tube or of a pad. Because the sheathing means is provided, it is possible to omit the separation means used hitherto between insert parts and mold. By virtue of the sheathing means, the mold does not come into contact with the resin. The finished component is obtained by introducing, in particular by use of suction, the resin into the interior of the sheathing means, where the fiber material is saturated.

The resilient sheathing means disadvantageously leads to undesired prestressing, which can affect the shaping of the component. Although no separation means is required for the mold, a complicated method is required to remove the sheathing means from the finished component.

It is an object of the invention to state a simplified production process for a surface-finished component made of a fiber composite material. Another object of the invention is to provide a fiber composite component which is easy to produce and which has a finished surface.

The first object mentioned is achieved in the invention through a process for the production of a component made of a fiber composite material, where a foil composite with a thermoplastic outer foil and with a thermoplastic inner foil is produced, where the modulus of elasticity of the inner foil within a temperature range is smaller than the modulus of elasticity of the outer foil, where the inner foil of the foil composite is bonded to a molding comprising a fiber material and comprising a thermoset, where the molding is hardened, and where the foil composite is subjected to a heat treatment in the temperature range within which the modulus of elasticity of the inner foil is smaller than the modulus of elasticity of the outer foil, where the outer foil undergoes stress relaxation.

The individual production steps here do not necessarily have to proceed in the stated sequence. Instead, it is also possible to vary the sequence in any useful manner. In particular, the bonding of the foil composite can be undertaken before, with, or else after the hardening of the molding. It is also not essential that the heat treatment of the foil composite takes place after the hardening of the molding, but instead it is also in particular possible that it takes place during the hardening of the molding, preferably when the molding is subjected to a simultaneous molding process to give a final product.

The invention proceeds from the idea of finding a process-integrated approach to the surface finishing of a fiber composite component. A particular intention is to omit, as far as possible, complicated additional process steps for the avoidance of fiber perceptibility, for example to omit any preformed additional layer of material or any subsequent leveling process to remove the undesired perceptibility, for example the application of a trowelled and sanded layer of filler, the subsequent application of foils by adhesive bonding, or repeated coating with intermediate curing and sanding. Additional necessary process steps of this type lead to increased use of auxiliary materials, to increased cycle time, to additional utilization of capital and plant, and also to reduced competitiveness of the fiber composite components in comparison with existing metallic solutions. A process-integrated approach can avoid these disadvantages.

To this end, a first step of the invention proceeds from the fundamental physical observation that material objects strive toward a state of minimum energy. In particular, objects subject to a mechanical stress strive toward a lower-energy state, by way of example, through a reaction in which they deform and thus relax.

A second step of the invention starts from the idea that through bonding of a thermoplastic foil to the molding, for example by a treatment that uses pressure or heat and that takes place before, during, or after the introduction of the thermoset, it is possible to achieve a smooth surface at the start of the chemical reaction that leads to the solidification of the thermoset. The thermoplastic foil has then been securely bonded via adhesive forces to the composite structure of the molding. However, since during the course of hardening the matrix made of the thermoset increasingly exhibits shrinkage, the magnitude of which varies locally, the foil becomes distorted in a manner that corresponds to perceptibility of the fibers. The fiber bundles of the fiber material become perceptible here right through the foil as far as the surface. In other words, the matrix volume reduction associated with an increasing degree of hardening of the matrix leads to a locally varying increase in the stress within the foil, since the foil has been securely bonded to the composite structure. Local depressions arise in the foil, and render the fiber architecture visible at the surface. At the depressions there is a local increase in the stress within the foil.

A third step of the invention recognizes that, by using different thermal profiles of modulus of elasticity in the foil structure, the physical striving of the foil toward a stress reduction can be utilized in a heat-conditioning process for the smoothing of the surface. If, namely, a foil composite is produced with a thermoplastic outer foil and with a thermoplastic inner foil, where the modulus of elasticity of the inner foil within a certain temperature range is smaller than the modulus of elasticity of the outer foil, the outer foil will relax, with smoothing, in the region of the different moduli of elasticity by virtue of its greater modulus of elasticity, i.e. the proportionality factor between stress and tensile strain, whereupon the inner foil follows through deformation. The smoothed state with relaxed outer foil will have lower energy overall than the initial state, and the smooth surface is therefore retained. The outer foil has undergone stress relaxation by way of reduced tensile strain, with smoothing of the surface.

In other words, the invention permits the production of a fiber composite component where a foil has been durably and securely bonded as exterior surface to the composite structure in particular via adhesion, and where the undesired perceptibility of the fiber architecture has been eliminated through a simple heat-treatment process or simple heat-conditioning process without any further complicated additional measures. The bonded thermoplastic foil composite moreover improves the shatter properties of the fiber composite component.

The invention makes use here, in a composite material, of the spontaneous process of directional relaxation with energy reduction, in order to achieve a desired improvement of surface properties through a heat treatment.

The invention also in particular does not exclude spontaneous occurrence of the relaxation process at room temperature. However, it will generally be desirable to carry out the heat treatment at higher temperatures in order to increase the relaxation rate.

The hardening of the thermosets takes place through crosslinking of polymer chains with one another or with monomers (polycondensation, polyaddition, polymerization). The crosslinking or hardening is initiated by means of heat, radiation, or chemical additives. After the curing reaction, the molding has therefore hardened chemically, i.e. through durable, thermoset crosslinking. Its overall resultant character is that of a thermoset.

It is preferable that the foil composite is produced with a thermoplastic outer foil and with a thermoplastic inner foil, where the softening point of the inner foil is lower than the softening point of the outer foil, and where the foil composite is subjected to the heat treatment at a temperature between the two softening points, where the inner foil undergoes stress relaxation due to softening.

In this advantageous embodiment, the stress-reduction process is based on a decrease of the modulus of elasticity in the inner foil once the softening point has been reached, while the tensile strain is reduced in the outer foil through smoothing. The modulus of elasticity in particular in a plastic is known to decrease once the softening point, also known as glass transition temperature T_{g}, has been reached. The plastic is converted from a brittle state with a high modulus of elasticity to a soft state with a reduced modulus of elasticity. The transition to the liquid phase here is gradual.

If the heat treatment for the foil composite is carried out at a temperature between the softening point of the inner foil and the softening point of the outer foil, a logical conclusion is that the stress in the inner foil decreases as a result of softening, i.e. as a result of the thermal decrease in the modulus of elasticity. The material of the inner foil flows into the regions of the increased stresses within the outer foil and thus arrives at the locations which were previously filled with thermoset matrix. At the same time, a stress reduction occurs in the outer foil as a result of raising of same, which additionally assists the flow of the material in the inner foil. In other words, the inner foil softens and becomes plastically deformable in the thickness direction, while the external foil continues to absorb stresses. Within this temperature range, the energy of the outer foil is reduced via relaxation of precisely those stresses that were introduced via the areas of fiber-perceptibility. In the region of the inner foil, the stress level is reduced through reduction of the modulus of elasticity. Material of the inner foil therefore flows into the regions of locally reduced pressure, induced via the stress present in the outer foil. Areas of fiber-perceptibility that have arisen during the hardening of the thermoset matrix are mitigated by simple heating.

The mechanism used for this effect is based on the directional relaxation of the foil composite, where said foil composite has depressions as a consequence of the shrinkage of the thermoset prior to the heat treatment and is thus subject to local stress. By virtue of the combination of the heat treatment with the different softening points, the stress in the inner foil undergoes relaxation by way of a decrease of the modulus of elasticity, and the outer foil undergoes relaxation by way of reduced tensile strain, with smoothing of the surface.

A heat-treatment process for the smoothing of the surface can easily be integrated into an existing process for the production of a fiber composite component, since the forming process for, and the hardening of, the molding/preform generally takes place with exposure to heat. If by way of example dry fiber preforms are processed by means of an RTM process, the time during which the press is occupied is a dominant cost factor. Consequently, in order to save cycle time, matrix systems in the RTM process are only partially cured in the press, and are then fully hardened in an oven. This subsequent process of exposure to heat without constriction in a mold leads to undesired perceptibility of the fibers, because the volume of the matrix is again reduced. However, for the purposes of the present invention, this subsequent heat-conditioning can also be utilized directly and without further process steps for the smoothing of the stated foil composite. The expression RTM process here means what is known as a resin-transfer-molding process where the hardening of the thermoset is combined with a step of a compression process or forming process. However, in an alternative, the heat treatment of the foil composite can also take place in a simple manner with conservation of resources via hot air or via irradiated heat, where the foil composite bonded to the molding or to the component is treated locally for the smoothing process.

In the course of the present process, the inner foil is bonded to the molding. This bonding, based on adhesion, can take place prior to, during or after the hardening of the molding, and in particular in turn in a manner that is process-integrated. Said adhesion results inter alia from mechanical anchoring, where pores and depressions in the inner foil are by way of example penetrated by the liquid thermoset during the saturation process and in the hardened, solid state form undercuts. On the other hand, it is possible, if the thermoset used and the thermoplastic inner foil used are appropriate, that what is known as autoadhesion takes place during the production process, where the hydrocarbon chains of the polymers used become mutually superposed or penetrate into one another, and the two materials therefore finally are held by intermolecular forces. Equally, electrostatic interactions, Van der Waals forces, dipole interactions, and the like can lead to specific adhesion in the finished component. For the purposes of the invention, all of these adhesion effects, some of which are not clearly separable, can be utilized for durable and inseparable bonding of the foil during the hardening process. To this extent, the invention excludes those pairings of materials where the thermoplastic inner foil and the thermoset can easily be separated from one another after hardening. By way of example, this is the case with plastics that differ in respect of their polarity or chemically in such a way that by way of example no mutual wetting or interpenetration can take place in the liquid phase. These pairings of materials are by way of example conventionally used in order to design a foil coating that is easily peelable.

The selection of the inner foil is advantageously such that by way of example via heating it mixes in the form of liquid phase with the thermoset or it penetrates into the fiber material. The hardening process thus gives a durably strong bond that by virtue of interlock bonding is inseparable. This type of bonding can also be called mechanical adhesion.

It is preferable that the molding is subjected to a forming process before the heat treatment for the stress relaxation of the outer foil. However, in an alternative that can be provided, the smoothing of the outer foil is undertaken through a heat treatment during the forming process in a single operation. If, for the production process, in particular the introduction of the thermoset, the forming process and the hardening take place in an RTM process in combination at approximately the same time in an operation or in a compression step, this also permits the invention optionally to achieve the smoothing of the foil composite simultaneously during said embossing step.

In another preferred embodiment, the foil composite is bonded to the molding by laying the inner foil of the foil composite on a dry fiber material and using a heat treatment to soften the inner foil, where material of the softened inner foil penetrates into the fiber material. Only then is the thermoset introduced in the form of liquid with saturation of the fiber material. Accordingly, in this process the material of the inner foil becomes bonded to the fibers of the dry fiber material via exposure to heat before the introduction of the thermoset, and individual filaments of the semi-finished fiber product therefore become fused to the inner side of the foil. After the saturation of the dry fiber material with the thermoset and hardening thereof, areas of fiber perceptibility initially arise. Said areas of fiber perceptibility are mitigated by the further heat treatment of the component. The thermal bonding of the inner foil to the fiber material can be assisted by exposure to mechanical pressure or vacuum. It is thus possible to control the depth of penetration of the softened material of the inner foil into the fiber material. When the resultant structure is wetted with the thermoset, individual filaments of the fiber material become embedded in some sections within the material of the inner foil and in some sections in the thermoset matrix.

Tests on sections of fiber composite components thus produced revealed that failure of the thermoset matrix occurs before any failure of the mechanically bonded inner foil.

In an alternative, the foil composite is bonded to the molding by laying the inner foil of the foil composite on a dry fiber material, then the thermoset is introduced in the form of liquid with saturation of the fiber material, and then a heat treatment is used to soften the inner foil. Material of the softened inner foil here penetrates locally into the fiber material and/or alternatively or additionally mixes with the thermoset and/or forms an adhesive boundary region with the thermoset here. In other words, the softening of the material of the inner foil has been coupled here with the hardening of the thermoset. This, too, produces a durable bond due to undercuts. This process too, can be pressure- and/or vacuum-assisted.

It is preferable that the liquid thermoset is introduced by means of a pressure difference. This can be achieved by way of example through an infiltration process where a subatmospheric pressure is applied to the preform in such a way that the liquid thermoset is sucked, as binder material, into the interior. Uniform saturation of the fiber material is thus achieved. On the other hand, it is also possible to achieve the saturation through an injection process, where the liquid thermoset is itself introduced under pressure into the interior. In both possibilities, it is useful to utilize, for the introduction process, a pressure prevailing in the interior of the preform.

During the production process, the stated foil composite becomes durably bonded, as surface, to the component, in particular in a process-integrated manner. By way of example, during the forming process applied to the molding, the thermoplastic foil is adapted appropriately for a desired topography of the finished component, with exposure to heat. No additional process step of the type required hitherto for the shaping of an exterior layer of material is necessary for this purpose.

Hardening of the thermoset and completion of heat treatment for the relaxation of the outer foil produces a component made of a fiber composite material, important surface properties of which are determined via the foil composite. When important surface properties are determined by a foil, this provides increased possibilities for modularization. Whereas differences of color and of surface in the final product can occur in enterprises with little vertical integration of manufacturing or when there is a plurality of suppliers, these phenomena are reliably avoided when one central foil producer is utilized as supplier for the foil composite. The process parameters for the materials of the surface have been separated from the parameters for the production of the structure. A foil can be manufactured in dedicated processes, and this permits production of a wide variety of materials with different properties at comparatively low cost. It is also possible to bond a plurality of materials of this type with desired properties in layers to give a combined foil, where the invention simply provides one exterior outer foil and one inner foil with specific properties in relation to one another in respect of modulus of elasticity. The involvement of additional foil layers is not excluded, but indeed where appropriate is preferred.

By virtue of the foil composite bonded as surface it becomes possible to achieve desired surface properties of composite components via appropriate adaptation of a foil production process, while on the other hand there is no need to use complicated process steps to supplement the production process for the fiber composite component.

The bonding of the foil composite for the surface finishing of the finished component can preferably also result from simultaneous utilization of the foil to improve the handling of a dry preform made of fiber layers. To this end, before a stack made of dry layers of a fiber material is saturated, it is sheathed with the thermoplastic foil composite. The interior between the foil composite and the dry layers of the fiber material prior to saturation is then subjected to suction from a pump, or evacuated.

This gives a preform which has protection from external effects such as dust and moisture and which, unlike a preform without foil, can by way of example be positioned automatically, because it has relatively high intrinsic stiffness. The dry preform inside the welded material is resistant to aging and can therefore also be transported over relatively long distances. There is no risk of undesired hardening, as is the case by way of example with a saturated prepreg, since no binder material has been used to provide dimensional stability to the fiber material or for the prefabrication of a preform in the context of a sandwich structure.

The use of a preform that is stable during transport permits full utilization of the logistic advantages of a decentralized press process via reduced lay-up times in the press cavity. Introduction of the liquid thermoset into the interior between the foils, with saturation of the fiber material, can be delayed until a juncture immediately prior to or during the final shaping process. The subatmospheric pressure in the interior can be used here advantageously for the desired uniform saturation of the fiber material.

The production of the foil composite can in principle be achieved by way of various known processes. By way of example, outer foil and inner foil can be pressed with one another, or calendered. It is also possible to produce one of the two foils as outer foil and then to apply the other foil by an injection process. In the latter case, the bonding of the two foils to one another is achieved by way of example through a subsequent chemical reaction. It is also possible to produce the foil composite by applying, to an outer foil, a monomer and a reactant which leads to the polymerization of the second foil.

It is preferable that the foil composite is produced by coextrusion of outer foil and inner foil. The technology of the coextrusion process is well understood, and this is a familiar process that is comparatively advantageous. Coextrusion produces the bond between outer foil and inner foil through simultaneous melting of the materials of the two foils. The polymers thus interpenetrate one another, and can also react chemically. In particular, bonding of the two foils to one another results from mechanical adhesion and/or from chemical effects.

The provision of an inner foil and of an outer foil can moreover decouple the adhesion function from the desired surface properties. It is thus possible that the outer foil alone uses the material optimized for the desired surface properties. By way of example, a surface property such as acid resistance, aging resistance, weathering resistance, hardness, haptic characteristics, or else coloring, etc. can be allocated separately to the exterior outer layer in the foil composite.

Fibers used can comprise glass fibers, carbon fibers, natural fibers, thermoplastic synthetic fibers, and/or aramid fibers. It is thus possible to take the subsequent characteristic properties of the desired fiber composite into consideration. It is preferable that the fiber material itself takes the form of a textile, where the fibers have been bonded to one another to give a laid fiber scrim, a woven fiber fabric, a knitted fiber fabric, and/or a nonwoven fiber fabric. Another possible alternative is the use of a fiber paper. The latter differs from a nonwoven fiber fabric, where fibers have usually been bonded to one another in an unordered manner for example by needling, in the finer structure of the fibers and the interior surface produced by pressing. On the other hand, there are also known fiber fabrics in which fibers have orientation along a preferential direction.

It is advantageous to use a fiber material which has a preferential direction of fiber orientation. Fiber materials of this type are increasingly used for components made of a fiber composite material with prescribed mechanical properties. Semi-finished random fiber products can assume ancillary functions in the achievement of desired surface properties on the surface of the fiber structure. To this end, these are introduced between foil composite and directional semi-finished fiber products.

In another preferred variant here, a random fiber material is placed on a fiber material with fiber orientation along a preferential direction, and the foil composite is bonded to the applied random fiber material. It is thus possible to reduce the foil thickness in the foil composite, since the amount of unevenness present on the surface of the hardened fiber composite and requiring compensation via the relaxation of the foils is smaller. The surface nonwovens in particular introduced serve here primarily to improve the surface and contribute only slightly to the ability of the structure to fulfill structural functions. The predominant proportion of the fiber material is a fiber material in which fibers have orientation along a preferential direction. To this extent, the mechanical properties of the finished component are determined by the oriented fiber material.

Outer foil preferably used comprises a plastic selected from the group consisting of PMMA (polymethyl methacrylate), PC (polycarbonate), SAN (styrene-acrylonitrile), PVF (polyvinyl fluoride), and PVC (polyvinyl chloride), or uses a combination thereof. It is also possible to select, alongside these, advantageous plastics such as PE (polyethylene) or PA (polyamide) if the component is by way of example produced for an interior sector.

Inner foil used preferably comprises a plastic selected from the group consisting of EVA (ethylene-vinyl acetate), PCP (polychlorinated biphenyls), APAO (amorphous poly-alpha-olefins), ABS (acrylonitrile-butadiene-styrene), TPE-U (thermoplastic elastomers based on urethane), TPE-E (thermoplastic copolyesters), TPE-A (thermoplastic copolyamides), EVOH (ethylene-vinyl alcohol), and PE (polyethylene), or uses a combination thereof.

In order to produce the foil composite it is necessary in each case to select at least one plastic from the group of the materials of the outer foil and at least one plastic from the group of the materials of the inner foil, where the moduli of elasticity in at least one temperature range or the softening points, as described above, differ from one another appropriately. By way of example, PC is used as outer foil and EVA is used as inner foil. The softening point of PC is about 220° C. EVA exhibits a softening point of about 150° C. Examples of other individual pairings are PC as outer foil and ABS as inner foil and PMMA as outer foil and EVOH as inner foil.

In principle it is also possible within the groups mentioned to mix the respective plastics listed in any desired manner with one another in order to obtain the moduli of elasticity or softening points for the respectively desired intended use of the fiber composite component. By way of example, the softening point can be set lower when lower persistence to temperature change is demanded for the subsequent fiber composite component. In other cases it is necessary to set the softening point higher when the fiber composite component is intended to withstand higher temperatures.

Another great advantage of the provision of an exterior foil as surface of the fiber composite component is that the component can be joined without difficulty to other components by a thermal method. In particular, the thermoplastic foil can be joined to another component either by means of welding or else by means of fusion. In the case of the welding process, the two components are heated locally, or over an area, above the softening point. During this process, the materials interpenetrate one another. When plastics are joined, a boundary region can develop in which the polymers bond via formation of a region of diffusion. To this extent, the welding process is particularly suitable for joining the abovementioned component, after production, to another component made of plastic. In the case of the fusion process, only one component is heated above the softening point. The bonding to the other component then takes place via adhesion and physical or mechanical bonding. Accordingly, the fusion process can be used to join the abovementioned component, after production, by way of example to another component made of metal. A component produced as described above accordingly has the great advantage that it can be joined to other components without use of any adhesive process.

The object mentioned in the introduction is further achieved in the invention via a component made of a fiber composite material and in particular produced by the process described above. This type of component comprises a fiber material bonded in a matrix made of a thermoset, and also comprises a surface layer made of a foil composite with a thermoplastic outer foil and with a thermoplastic inner foil, where the modulus of elasticity of the inner foil within a temperature range is smaller than the modulus of elasticity of the outer foil, where the inner foil has been bonded directly to the thermoset and/or to the fiber material, and where the outer foil has undergone stress relaxation.

In one preferred embodiment, the softening point of the inner foil is lower than the softening point of the outer foil.

Other advantageous embodiments of the component can be derived from the principles of the statements made in relation to the production process. There are correspondingly resultant advantages transferred to the component.

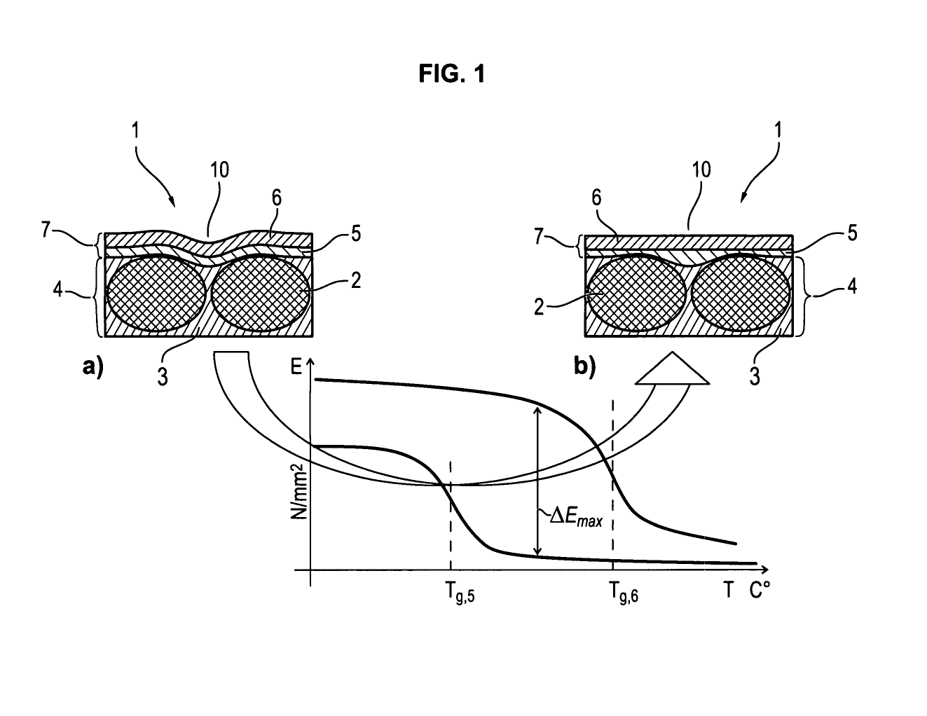

An embodiment of the invention is explained in more detail with reference to a drawing. The single FIG. 1 is a diagram of a component 1 made of a fiber composite material in two different stages a) and b) of the production process.

The component 1 made of the fiber composite material comprises a fiber material or fibers 2 bonded into a matrix made of a thermoset 3. A foil composite 7 made of an outer foil 6 and of an inner foil 5 has been securely bonded through mechanical adhesion to the molding 4 made of the fiber material 2 and of the thermoset 3. By way of example, there is an epoxy resin provided as thermoset 3. The inner foil 5 has been produced from EVA. The outer foil 6 is composed of PC. The inner foil 5 and the outer foil 6 have been produced in the form of foil composite 7 by way of example by coextrusion. The softening point of the outer foil 6 is higher than that of the inner foil 5.

The foil composite 7 was pressed with the dry fiber material 2 with exposure to heat. The material of the inner foil 5 softens here, penetrates into the first fiber layers, and thus gives secure bonding between the fiber material 2 and the foil composite 7. The resultant structure is then wetted with the thermoset 3. Individual filaments of the fiber material 2 become embedded in some sections within the material of the inner foil 5 and in some sections within the material of the thermoset 3. After the molding 4 with foil composite 7 bonded thereto has been subjected to a forming process, the thermoset 3 is hardened, for example by introducing heat.

State (a) shows the component 1 after hardening of the thermoset 3 has taken place. The hardening of the thermoset 3 causes volume shrinkage in the matrix, and this leads to build-up of stress in the foil composite 7 bonded thereto. Local depressions 10 occur between the fibers of the fiber material 2. There is undesirable perceptibility of the fiber architecture through the foil composite 7.

A heat treatment of the component 1 then takes place at a temperature between the softening point of the inner foil 5 and the softening point of the outer foil 6. In this connection, the graph included in the drawing shows the temperature curve for the moduli of elasticity E of the two foils 5, 6. The curve for the lower modulus of elasticity E belongs here to the inner foil 5.

When the respective softening point T_{g} is reached, the modulus of elasticity E decreases. The respective plastic is converted from a brittle physical state with high modulus of elasticity E to a soft physical state with low modulus of elasticity E. The soft plastic gradually begins to flow.

The selection of the inner foil 5, EVA in the present case, is such that its softening point T_{g,5} is lower than the softening point T_{g,6} of the outer foil 6, in the present case PC. The heat treatment takes place at a temperature in the range between the two softening points T_{g,5} and T_{g,6} within which there is a maximal difference ΔEₘₐₓ between the two moduli of elasticity.

When the component 1 corresponding to state (a) is heated beyond the softening point T_{g,5}, the stress built up at a depression 10 can be dissipated in the inner foil 5 via the reduction of the modulus of elasticity E. The material of the inner foil 5 becomes plastically deformable. The outer foil 6 continues to absorb stresses. In the outer foil 6, an energy reduction occurs through relaxation of the stresses that were introduced via the areas of fiber perceptibility. The outer foil 6 is raised in the region of the depressions 10. The outer foil 6 becomes smooth. The material of the inner foil 5 flows into the regions of locally reduced pressure, induced via the stress present in the outer foil 6. The volume that increases by virtue of the raising of the outer foil 6 is compensated via consequential flow of material of the inner foil 5.

It can be seen that a simple heat treatment reverses the undesired perceptibility of the fiber architecture in the surface, where the striving of a material object toward a state of lower energy is utilized via skilled selection of the parameters of materials and via use of a foil composite. There is no need for complicated downstream operations.

Surface qualities were recorded in in-house experiments with varying layer thicknesses of the foil composite 7, with varying processing parameters (injection pressure, temperature, retention time), and variations in the semi-finished fiber product (coarse woven fabric, fine woven fabric, nonwoven fabric, laid scrim). A factor common to all of these is that areas of fiber perceptibility develop to various extents at the surface in the state (a).

It was found that, through the use of a foil composite made of an outer foil and of an inner foil, where the outer foil has, within a temperature range, a higher modulus of elasticity than the inner foil or a higher softening point than the inner foil, a marked improvement of surface quality is obtained through a simple heat treatment via heating to a certain temperature.

In order to determine surface quality, a microscopic method was specifically developed in which a pigment vehicle was applied to the surface of the finished component and simply decanted. The strongest pigmentation can then be determined optically at the depressions of the outer foil, since that is where the pigment vehicle accumulates. In the present case, a white pigment vehicle was used, and with increasing depth the depression therefore becomes white. The area treated with the pigment vehicle was recorded optically by means of a microscope, and the grey-scale values were then evaluated. It was possible to develop a reproducible measurement method for the assessment of the surface properties of the component via measurement of the proportion of white area and via additional qualitative evaluation in respect of the inclusion of white areas by surrounding black regions. The measurement method produces a comparative index. The standard deviation for the measurement method was 4%.

In all of the experiments carried out, it was found that use of the simple heat treatment markedly improved surface properties. The simple heat treatment within the particular temperature range leads to a smoothing of the outer foil due to stress relaxation. There is no longer any requirement for complicated downstream operations or complicated additional steps to achieve smooth surfaces without fiber perceptibility.

### Key

1 Component (made of fiber composite material)

2 Fiber, fiber material

3 Thermoset

4 Molding

5 Inner foil

6 Outer foil

7 Foil composite

10 Depression

E Modulus of elasticity

T_{g} Softening point

(T_{g,5}) Softening point of inner foil

(T_{g,6}) Softening point of outer foil

1. A process for the production of a component (1) made of a fiber composite material, where
a foil composite (7) with a thermoplastic outer foil (6) and with a thermoplastic inner foil (5) is produced, where the modulus of elasticity (E) of the inner foil (5) within a temperature range is smaller than the modulus of elasticity (E) of the outer foil (6),
the inner foil (5) of the foil composite (7) is bonded to a molding (4) comprising a fiber material (2) and comprising a thermoset (3),
the molding (4) is hardened, and
the foil composite (7) is subjected to a heat treatment in the temperature range within which the modulus of elasticity (E) of the inner foil (5) is smaller than the modulus of elasticity (E) of the outer foil (6), where the outer foil (6) undergoes stress relaxation.

2. The process as claimed in claim 1, where the foil composite (7) is produced with a thermoplastic outer foil (6) and with a thermoplastic inner foil (5), where the softening point (T_{g,6}) of the inner foil (5) is lower than the softening point (T_{g,6}) of the outer foil (6), and where the foil composite (7) is subjected to a heat treatment at a temperature between the two softening points (T_{g,6}, T_{g,6}), where the inner foil (5) undergoes stress relaxation due to softening.

3. The process as claimed in claim 1, where the molding (7) is subjected to a forming process before the heat treatment for the stress relaxation of the outer foil (5).

4. The process as claimed in claim 1, where the foil composite (7) is bonded to the molding (4) by laying the inner foil (5) of the foil composite (7) on a dry fiber material (2) and using a heat treatment to soften the inner foil (5), where material of the softened inner foil (5) penetrates into the fiber material (2), and then the thermoset (3) is introduced in the form of liquid with saturation of the fiber material (2).

5. The process as claimed in claim 1, where the foil composite (7) is bonded to the molding (4) by laying the inner foil (5) of the foil composite (7) on a dry fiber material (2), then the thermoset (3) is introduced in the form of liquid with saturation of the fiber material (2), and then a heat treatment is used to soften the inner foil (5), where material of the softened inner foil (5) penetrates into the fiber material (2) and/or forms an adhesive boundary region with the thermoset (3).

6. The process as claimed in claim 4, where the thermoset (3) is introduced by means of a pressure difference.

7. The process as claimed in claim 4, where the introduction of the thermoset (3), the forming process and the hardening take place in an RTM process in combination at approximately the same time in a compression step.

8. The process as claimed in claim 1, where the foil composite (7) is produced by coextrusion of the outer foil (6) and the inner foil (5).

9. The process as claimed in claim 1, where fiber material (2) used comprises a laid fiber scrim, a woven fiber fabric, a knitted fiber fabric, a fiber paper, and/or a nonwoven fiber fabric.

10. The process as claimed in claim 1, where fibers used comprise glass fibers, carbon fibers, natural fibers, thermoplastic synthetic fibers, and/or aramid fibers.

11. The process as claimed in claim 1, where outer foil (6) used comprises a plastic selected from the group consisting of PMMA, PC, SAN, ASA, ABS, PVF, and PVC, or a combination thereof.

12. The process as claimed in claim 1, where inner foil (5) used comprises a plastic selected from the group consisting of ABS, EVA, PCB, APAO, TPE-U, TPE-E, TPE-A, EVOH, and PE, or a combination thereof.

13. A component (1) made of a fiber composite material comprising a fiber material (2) bonded in a matrix made of a thermoset (3), and also comprising a surface layer made of a foil composite (2) with a thermoplastic outer foil (6) and with a thermoplastic inner foil (5), where the modulus of elasticity (E) of the inner foil (5) within a temperature range is smaller than the modulus of elasticity (E) of the outer foil (6), where the inner foil (5) has been bonded directly to the thermoset (3) and/or to the fiber material (2), and where the outer foil (6) has undergone stress relaxation.

14. The component (1) as claimed in claim 13, where the softening point (T_{g,6}) of the inner foil (5) is lower than the softening point (T_{g,6}) of the outer foil (6).

15. The process as claimed in claim 5, where the thermoset (3) is introduced by means of a pressure difference.

16. The process as claimed in claim 5, where the introduction of the thermoset (3), the forming process and the hardening take place in an RTM process in combination at approximately the same time in a compression step.

17. A component produced using the process of claim 1.
